(19) United States
(12) Patent Application Publication
(10) Pub. No.: US 2022/0069429 A1
(43) Pub. Date: Mar. 3, 2022

(54) POWER DIVIDER SUPPORT AND POWER DIVIDER ASSEMBLY FOR BASE STATION ANTENNA

(71) Applicant: CommScope Technologies LLC, Hickory, NC (US)

(72) Inventors: Fan He, Suzhou (CN); PuLiang Tang, Suzhou (CN); Ruixin Su, Suzhou (CN); Bo Wu, Suzhou (CN); Fusheng Lv, Suzhou (CN)

(21) Appl. No.: 17/389,901

(22) Filed: Jul. 30, 2021

(30) Foreign Application Priority Data
Aug. 25, 2020 (CN) 202021798771.7

(51) Int. Cl. H01P 5/12; H01Q 1/24; H01R 24/54

(52) U.S. Cl. CPC H01P 5/12; H01R 2201/02; H01R 24/547; H01Q 1/246

(57) ABSTRACT

The invention relates to a power divider support for a base station antenna. The power divider support is configured to be mounted on a panel assembly having a reflecting panel, the power divider support has a body, the body has a mounting area for mounting a power divider circuit board, the power divider support further has a plurality accommodation portions disposed adjacent to the mounting area, and the accommodation portions are configured to accommodate the end sections of coaxial cables. The present invention further relates to a power divider assembly for a base station antenna. The power divider assembly comprises a power divider circuit board, a plurality of coaxial cables and the power divider support, the power divider circuit board is mounted in the mounting area of the power divider support, and the end sections of the coaxial cables are accommodated in the accommodation portions of the power divider support. The power divider support is structurally simple and is easy to manufacture and mount.

### RELATED APPLICATION

The present application claims priority from and the benefit of Chinese Utility Model Application No. 202021798771.7, filed Aug. 25, 2020, the disclosure of which is hereby incorporated by reference herein in its entirety.

### FIELD OF THE INVENTION

The present invention relates to the technical field of base station antennas, and in particular relates to a power divider support for a base station antenna and a power divider assembly comprising such a power divider support.

### BACKGROUND OF THE INVENTION

Power dividers, which are widely used in base station antennas, may be used for power splitting and cable transfer splicing. For example, power dividers may divide input signals into a plurality of lines of signals and transmit the signals to radiator arrays of base station antennas.

### SUMMARY OF THE INVENTION

The present invention is intended to provide a power divider support for a base station antenna and a power divider assembly comprising such a power divider, wherein the power divider support may be structurally simple and easy to manufacture and mount.

To this end, a power divider support for a base station antenna is proposed. The power divider support is configured to be mounted on a panel assembly having a reflecting panel. The power divider support has a body, and the body has a mounting area for mounting a power divider circuit board. The power divider support further has a plurality accommodation portions disposed adjacent to the mounting area. The accommodation portions are configured to accommodate the end sections of coaxial cables.

The power divider support may be structurally simple and may be easy to manufacture and mount. The power divider support can be easily assembled together with coaxial cables and power divider circuit boards.

In some embodiments, the body may extend in an elongated manner.

In some embodiments, the accommodation portions may be disposed on at least one longitudinal side of the body, for example, on the two longitudinal sides of the body. The numbers of accommodation portions disposed on the two longitudinal sides may be the same or different.

In some embodiments, the body may have a rectangular central opening.

In some embodiments, the power divider support may have two legs bent from the body, the legs may respectively have a mounting hole, and the legs are fixed onto the panel assembly with the aid of the mounting holes.

In some embodiments, at least one accommodation portion of the plurality of accommodation portions is configured to be C-shaped and is configured to hold the insulation-removed end section of a coaxial cable. For example, all accommodation portions may be configured to be C-shaped.

In some embodiments, the power divider support may have longitudinal edges bent from the body, and at least one accommodation portion of the plurality of accommodation portions is formed in the longitudinal edges. For example, all accommodation portions are formed in the longitudinal edges.

In some embodiments, at least one accommodation portion may have a flange disposed on the outer side of the longitudinal edge. The flange may improve the accommodation of the end portion sections of coaxial cables in the accommodation portions. The flange may better prevent melted solder from falling off the power divider support when coaxial cables are soldered to the power divider support.

In some embodiments, the power divider support may have protruding portions transversely protruding from the body and at least one accommodation portion of the plurality of accommodation portions is formed in the protruding portion.

In some embodiments, the body may be configured to touch against the power divider circuit board on the whole circumference of the power divider circuit board in the mounting area.

In some embodiments, the power divider support may have a plurality of projections bent from the body and the projections are configured to mount the power divider circuit board.

In some embodiments, the at least one accommodation portion may have additional support members disposed on the inner side of the longitudinal edge, the support members are bent from the body, and the support members may be configured to solder with the external conductor of coaxial cables.

In some embodiments, the power divider support may be a stamping member of a metallic sheet.

According to another aspect of the present invention, a power divider assembly for a base station antenna is proposed. The power divider assembly comprises a power divider circuit board, a plurality of coaxial cables and the power divider support for a base station antenna according to the present invention, the power divider circuit board is mounted in the mounting area of the power divider support, and the end sections of the coaxial cables are accommodated in the accommodation portions of the power divider support.

The power divider assembly may have the technical advantages related to the power divider support.

In some embodiments, the power divider circuit board may be soldered together with the power divider support in the mounting area of the power divider support.

In some embodiments, the insulation of the coaxial cables may be removed from the end sections and the external conductors are soldered to the power divider support.

In some embodiments, the internal conductors of the coaxial cables in the end sections are soldered with the conductor trace on the power divider circuit board.

The technical characteristics mentioned above, the technical characteristics to be mentioned below, and the technical characteristics which may be obtained from the drawings may be combined arbitrarily as long as these technical characteristics do not conflict with each other. All technically feasible characteristic combinations are included in the description in the present application.

### BRIEF DESCRIPTION OF THE DRAWINGS

Various embodiments of the present invention are described by reference to the drawings. Where:

FIG. 1 is a perspective view of the power divider support according to a first embodiment of the present invention,

FIG. 2 is a perspective view of the power divider assembly according to a first embodiment of the present invention,

FIG. 3 is a perspective view of the power divider support according to a second embodiment of the present invention,

FIG. 4 is a perspective view of the power divider assembly according to a second embodiment of the present invention,

FIG. 5 is a perspective view of the power divider support according to a third embodiment of the present invention,

FIG. 6 is a perspective view of the power divider assembly according to a third embodiment of the present invention,

FIG. 7 is an enlarged partial view of the power divider assembly shown in FIG. 6,

FIG. 8 is a perspective view of the power divider support according to a fourth embodiment of the present invention, and

FIG. 9 is a perspective view of the power divider assembly according to a fourth embodiment of the present invention.

### DESCRIPTION OF THE EMBODIMENTS

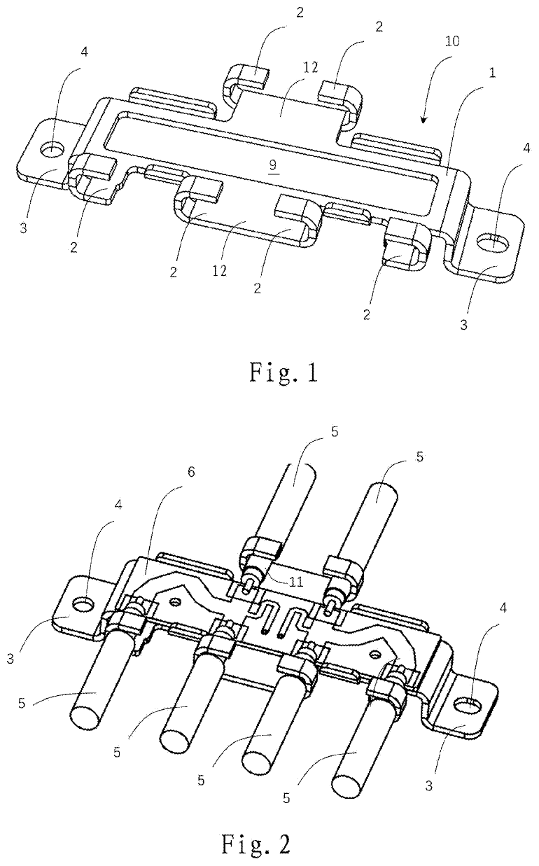

The power divider support 10 according to a first embodiment of the present invention and the power divider assembly comprising such a power divider support are first described by reference to FIGS. 1 and 2. The power divider support 10 may be a stamping member of a metallic sheet, and thus it is easy to manufacture the power divider support at a low cost. The power divider support 10 may be mounted on the panel assembly (not shown) of a base station antenna, and the panel assembly may comprise, for example, a reflecting panel and a feeder panel. The power divider support 10 has a body 1 and the body 1 has a mounting area where the power divider circuit board 6 is mounted. Adjacent to the mounting area, six accommodation portions 2 may be disposed, and the accommodation portions are configured to accommodate the end sections of coaxial cables 5. The number of accommodation portions 2 is only exemplary and may be set according to the practical requirements. The power divider support 10 may have two legs 3 bent from the body 1, the legs may respectively have a mounting hole 4, and the legs are fixed onto the panel assembly with the aid of the mounting holes 4 and the fasteners, for example, bolts or push rivets accommodated in the mounting holes 4.

The body 1 may extend in an elongated manner. The body 1 may have a rectangular central opening 9. The power divider circuit board 6 may engage the edges of the opening 9 on the whole circumference. The power divider circuit board 6 may be soldered together with the body 1. In an embodiment not shown, the power divider circuit board 6 may also be fixed onto the body 1 with the aid of a fastener. Two accommodation portions 2 may be disposed on one longitudinal side 13 of the body, and four accommodation portions 2 may be disposed on the other longitudinal side 13 of the body. The accommodation portions 2 may be respectively configured to be C-shaped and configured to hold the insulation-removed end sections of coaxial cables 5. In the embodiment shown in FIGS. 1 and 2, the power divider support 10 may have four protruding portions 12 transversely protruding from the body 1 and accommodation portions 2 may be formed in the protruding portions 12.

The external conductors 11 of coaxial cables 5 are exposed in the insulation-removed end sections and may be mechanically and electrically connected with the power divider support 10 through soldering. The power divider support 10 may directly touch the reflecting panel of the panel assembly not shown, and thus is grounded. Therefore, the external conductors 11 of coaxial cables 5 are also grounded. The internal conductors of coaxial cables 5 may be electrically connected with the conductor trace on the power divider circuit board 6 through soldering. Since the end sections of coaxial cables 5 are held by C-shaped accommodation portions 2, the deviation of the end sections of coaxial cables 5 from the preset soldering positions in the case of elastic rebound during soldering may be prevented. The accommodation portions 2 may have a preset width so as to reliably prevent melted solder from falling off the accommodation portions 2 during soldering.

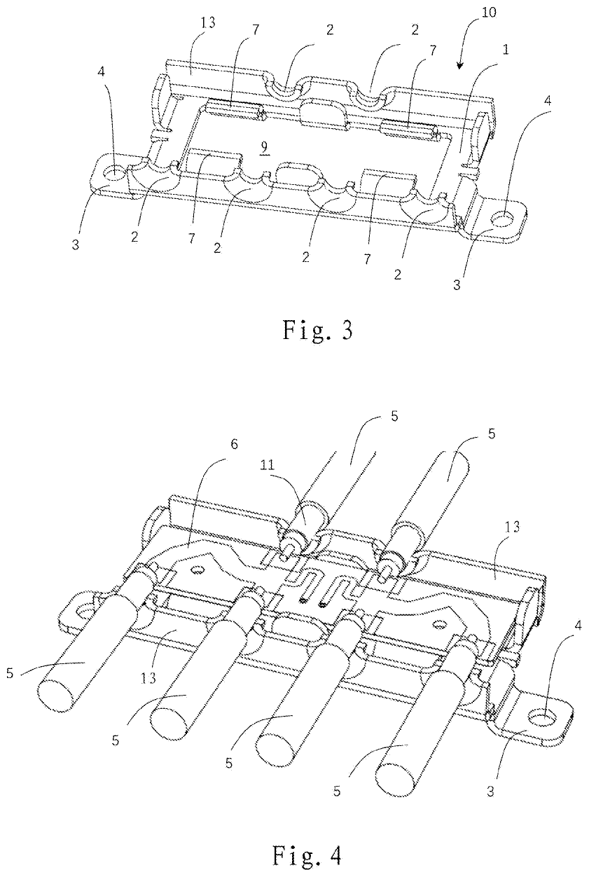

Next, the power divider support 10 according to a second embodiment of the present invention and the power divider assembly comprising such a power divider support are described by reference to FIGS. 3 and 4. The differences of the second embodiment from the first embodiment are described below. For other aspects, please refer to the description of the first embodiment. In the second embodiment, the power divider support 10 may have two longitudinal edges 13 bent from the body 1 and placed oppositely, and accommodation portions 2 may be formed in the longitudinal edges. The accommodation portions 2 may extend transversely inward by stamping a metallic sheet, and may roughly have the outline of a semicircle. The accommodation portions 2 may have an extension size at least twice the thickness of the metallic sheet in the transverse direction of the body 1 so that the insulation-removed end sections of coaxial cables 5 can be well accommodated and soldered in the accommodation portions. In addition, in the second embodiment, the power divider support 10 may have a plurality of projections 7 bent from the body 1, the projections may be disposed on the edges of the central opening 9, and the projections may be configured to mount the power divider circuit board 6.

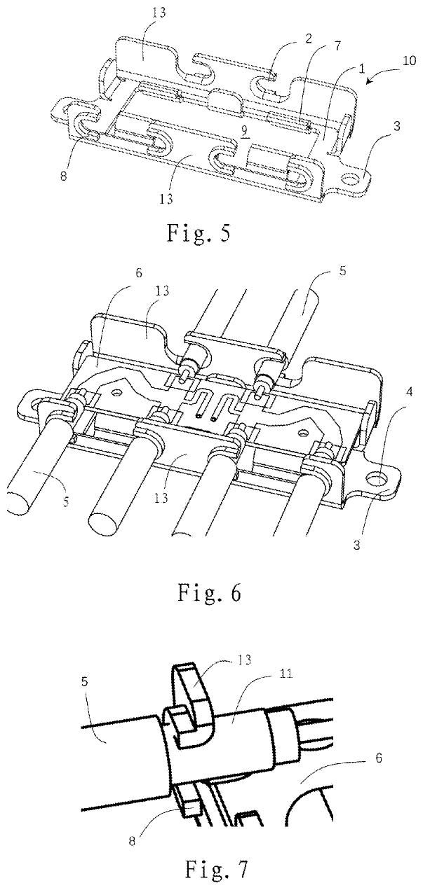

Next, the power divider support 10 in a third embodiment of the present invention and a power divider assembly comprising such a power divider support are described by reference to FIGS. 5 to 7. The differences of the third embodiment from the first embodiment are described below. For other aspects, please refer to the description of the first embodiment. In the third embodiment, the power divider support 10 may have two longitudinal edges 13 bent from the body 1 and placed oppositely, and the longitudinal edges may form accommodation portions 2. The accommodation portions 2 may be configured to be C-shaped. Flanges 8 may be provided for the accommodation portions 2 on the outer side of the longitudinal edges 13 so that the insulation-removed end sections of coaxial cables 5 can be well accommodated and soldered in the accommodation portions. In addition, in the third embodiment, the power divider support 10 may have a plurality of projections 7 bent from the body 1, the projections may be disposed on the edges of the central opening 9, and the projections may be configured to mount the power divider circuit board 6.

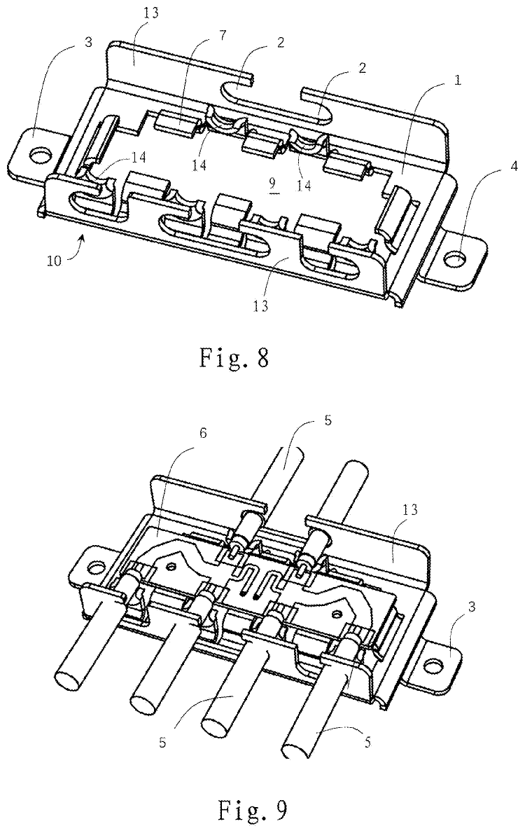

Finally, the power divider support 10 in a fourth embodiment of the present invention and the power divider assembly comprising such a power divider support are described by reference to FIGS. 8 and 9. The differences of the fourth embodiment from the third embodiment are mainly described below. For other aspects, please refer to the description of the third embodiment. In the fourth embodiment, the power divider support 10 may also have two longitudinal edges 13 bent from the body 1 and placed oppositely, the accommodation portions 2 can be formed in the longitudinal edges, and the accommodation portions 2 may be configured to be C-shaped. Additional support members 14 may be provided for the accommodation portions 2 on the inner side of the longitudinal edges 13, and the additional support members may be disposed on the edges of the central opening 9 and may be bent from the body 1. The insulation-removed end sections of coaxial cables 5 may be well accommodated by the accommodation portions 2 and the matched additional support members 14, and may be well soldered to the additional support members 14.

It will be understood that, the terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprise” and “include” (and variants thereof), when used in this specification, specify the presence of stated operations, elements, and/or components, but do not preclude the presence or addition of one or more other operations, elements, components, and/or groups thereof. As used herein, the term “and/or” includes any and all combinations of one or more of the associated listed items. Like reference numbers signify like elements throughout the description of the figures.

The thicknesses of elements in the drawings may be exaggerated for the sake of clarity. Further, it will be understood that when an element is referred to as being “on,” “coupled to” or “connected to” another element, the element may be formed directly on, coupled to or connected to the other element, or there may be one or more intervening elements therebetween. In contrast, terms such as “directly on,” “directly coupled to” and “directly connected to,” when used herein, indicate that no intervening elements are present. Other words used to describe the relationship between elements should be interpreted in a like fashion (i.e., “between” versus “directly between”, “attached” versus “directly attached,” “adjacent” versus “directly adjacent”, etc.).

Terms such as “top,” “bottom,” “upper,” “lower,” “above,” “below,” and the like are used herein to describe the relationship of one element, layer or region to another element, layer or region as illustrated in the figures. It will be understood that these terms are intended to encompass different orientations of the device in addition to the orientation depicted in the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive concept.

It will also be appreciated that all example embodiments disclosed herein can be combined in any way.

Finally, it is to be noted that, the above-described embodiments are merely for understanding the present invention but not constitute a limit on the protection scope of the present invention. For those skilled in the art, modifications may be made on the basis of the above-described embodiments, and these modifications do not depart from the protection scope of the present invention.

1. A power divider support for a base station antenna, the power divider support being configured to be mounted on a panel assembly having a reflecting panel, comprising:
a body with a mounting area for mounting a power divider circuit board; and
a plurality of accommodation portions disposed adjacent to the mounting area, wherein the accommodation portions are configured to accommodate end sections of coaxial cables.

2. The power divider support for a base station antenna as claimed in claim 1, wherein the body extend in an elongated manner and the accommodation portion is disposed on at least one longitudinal side of the rectangular body.

3. The power divider support for a base station antenna as claimed in claim 2, wherein the body has a rectangular central opening.

4. The power divider support for a base station antenna as claimed in claim 1, wherein the power divider support has two legs bent from the body and each of the legs respectively has a mounting hole, and the legs may be fixed onto the panel assembly with the aid of the mounting holes.

5. The power divider support for a base station antenna as claimed in claim 1, characterized in that at least one accommodation portion of the plurality of accommodation portions is configured to be C-shaped and is configured to hold the insulation-removed end section of a coaxial cable.

6. The power divider support for a base station antenna as claimed in claim 1, wherein the power divider support has longitudinal edges bent from the body and at least one accommodation portion of the plurality of accommodation portions is formed in the longitudinal edge.

7. The power divider support for a base station antenna as claimed in claim 6, wherein the at least one accommodation portion has a flange disposed on the outer side of the longitudinal edge.

8. The power divider support for a base station antenna as claimed in claim 6, wherein the at least one accommodation portion has additional support members disposed on the inner side of the longitudinal edge, the support members are bent from the body, and the support members are configured to solder with the external conductor of coaxial cables.

9. The power divider support for a base station antenna as claimed in claim 1, wherein the power divider support has protruding portions transversely protruding from the body and at least one accommodation portion of the plurality of accommodation portions is formed in the protruding portion.

10. The power divider support for a base station antenna as claimed in claim 1, wherein the body is configured to touch against the power divider circuit board on the whole circumference of the power divider circuit board in the mounting area.

11. The power divider support for a base station antenna as claimed in claim 1, wherein the power divider support has a plurality of projections bent from the body and the projections are configured to mount the power divider circuit board.

12. The power divider support for a base station antenna as claimed in claim 1, wherein the power divider support is a stamping member of a metallic sheet.

13. A power divider assembly for a base station antenna, comprising:
a power divider circuit board;
a plurality of coaxial cables; and
a power divider support for a base station antenna as claimed in claim 1;
wherein the power divider circuit board is mounted in the mounting area of the power divider support, and the end sections of the coaxial cables are accommodated in the accommodation portions of the power divider support.

14. The power divider assembly for a base station antenna as claimed in claim 13, wherein the power divider circuit board is soldered together with the power divider support in the mounting area of the power divider support.

15. The power divider assembly for a base station antenna as claimed in claim 13, wherein the insulation of the coaxial cables is removed from the end sections and the external conductors are soldered to the power divider support.

16. The power divider assembly for a base station antenna as claimed in claim 13, wherein the internal conductors of the coaxial cables in the end sections are soldered with the conductor trace on the power divider circuit board.
